(19) United States
(12) Patent Application Publication
(10) Pub. No.: US 2015/0352610 A1
(43) Pub. Date: Dec. 10, 2015

(54) MICROBIAL COMPOSITIONS FOR HYDROCARBON REMEDIATION AND METHODS OF USE THEREOF

(71) Applicant: BiOWiSH Technologies, Inc., Cincinnati, OH (US)

(72) Inventors: Richard S. Carpenter, West Chester, OH (US); Michael Stanford Showell, Cincinnati, OH (US); Joseph Roberts, Cincinnati, OH (US)

(21) Appl. No.: 14/734,792

(22) Filed: Jun. 9, 2015

Related U.S. Application Data
(60) Provisional application No. 62/009,592, filed on Jun. 9, 2014.

(51) Int. Cl. B09C 1/10; B09C 1/02; E21B 21/06

(52) U.S. Cl. CPC B09C 1/10; E21B 21/066; B09C 1/02

(57) ABSTRACT

The present invention relates to microbial compositions and a process for reducing hydrocarbon contamination.

### RELATED APPLICATIONS

This application claims priority to and benefit of provisional application U.S. Ser. No. 62/009,592 filed on Jun. 9, 2014, the contents of which are herein incorporated by reference in its entirety.

### FIELD OF THE INVENTION

The present invention relates to microbial compositions for hydrocarbon remediation and methods of using the compositions to reduce hydrocarbon contaminant from soil, sediment, oil-well drill cuttings, aquifer material or water.

### BACKGROUND OF THE INVENTION

Hydrocarbon contamination exists in groundwater and soil at thousands of sites around the world. This contamination is often the result of accidental release of fuels (e.g. gasoline or diesel fuel), or fluids and material (crude oil, drill cuttings) from drilling operations storage, transport, or transfer devices including but not limited to storage terrestrial treatment cells, tanks, pipelines, dispenser pumps, rail cars, and tank trucks. This petroleum contamination often presents a health risk to humans or local ecological systems, therefore it is desirable to destroy or remove the contamination.

Groundwater is a valuable natural resource due to its use as drinking water in many areas, as well as its importance in ecology and natural water cycles. In order to protect natural resources and rehabilitate contaminated groundwater, many technologies exist for removal or destruction of petroleum hydrocarbon contamination in groundwater and soil. Treatment methods range from simple physical removal and disposal of contaminated soil and water to more complex methods such as destruction of contaminants by natural or enhanced biodegradation (bioremediation) or chemical transformation. In particular, bioremediation has been used extensively to remediate sites contaminated with petroleum hydrocarbons in a cost effective manner.

Bioremediation of hydrocarbons typically involves microbial oxidation of the petroleum constituents into carbon dioxide and water and requires an electron acceptor to act indirectly as an oxidant in the process. Suitable electron acceptors include but are not limited to oxygen, sulfate, and nitrate. Although the specific bacteria and mechanisms differ for each electron acceptor, one may add any of these electron acceptors to stimulate bioremediation of petroleum hydrocarbons in soil and water mixtures. Thus a need exists for microbial compositions that are capable of bioremediation of hydrocarbons.

### SUMMARY OF THE INVENTION

In various aspects, the invention provides bacterial compositions that are useful in hydrocarbon remediation and methods of using the compositions to reduce hydrocarbon contaminant from soil, sediment, aquifer material or water. The bacterial compositions contain a mixture of bacteria comprising Pseudomonas and Bacillus. In some aspects, the compositions may additionally contain Rhodococcus, Arthrobacter, and Ochrobactrum species.

In some aspects the each of the Pseudomonas and Bacillus organisms in the mixture are present in equal proportions. Preferably the microbial mixture comprises Bacillus and Pseudomonas in a ratio from 1:1 to 1:10.

Bacillus organisms include for example, Bacillus subtilis, Bacillus amyloliquefaciens, Bacillus licheniformis, Bacillus niacin, Bacillus pumilis, Bacillus thurengiensis, Bacillus cereus, Bacillus napthovorans, and Bacillus megaterium. Pseudomonas organisms include for example, Pseudomonas zooglea, Pseudomonas alkaligenes, Pseudomonas frateuria, Pseudomonas putida, Pseudomonas aeruginosa, Pseudomonas azotifigens, Pseuodomonas azotoformans, Pseudomonas chlororaphis, Pseudomonas corrugata, Pseudomonas extremorientalis, Pseudomonas fiavescens, Pseudomonas fragi, Pseudomonas graminis, Pseudomonas japonica, Pseudomonas marginalis, Pseudomonas migulae, Pseudomonas monteilii, Pseudomonas mosselii, Pseudomonas nitroducens, Pseudomonas olveovorans, Pseudomonas plecoglossicida, Pseudomonas pseudoalcaligenes, Pseudomonas psychrophila, Pseudomonas stutzeri, Pseudomonas taiwanensis, Pseudomonas veronii, and Pseudomonas fluorescens.

In various embodiments the microbial mixture comprises Bacillus subtilis, Bacillus amyloliquefaciens, Bacillus licheniformis, Bacillus pumilus, Pseudomonas fluorescens, and Pseudomonas putida.

In some embodiments the microbial mixture further contains at least one bacterium selected from the genus Rhodococcus, Arthrobacter, and Ochrobactrum.

The Rodococcus bacterium is for example, Rhodococcus zopfii or Rhodococcus rhodochrous The Arthrobacter bacterium is for example, Arthrobacter rseoparaffinus, Arthrobacter petroleophagus, Arthrobacter paraffineus, and Arthrobacter rubellus The Ochrobactrum is preferably, Ochrobactrum anthropic.

In other aspects the microbial mixture contains Bacillus subtilis, Bacillus amyloliquefaciens, Bacillus licheniformis, Bacillus pumilus, Pseudomonas fluorescens, Pseudomonas putida, Rhodococcus zopfii, Arthrobacter rseoparaffinus, Arthrobacter petroleophagus, Arthrobacter paraffineus, Rhodococcus rhodochrous, Ochrobactrum anthropic, and Arthrobacter rubellus.

Also included is the invention are water soluble formulations containing the microbial hydrocarbon remediation compositions according to the invention, an inert carrier, an organic emulsifier and a yeast extract, wherein the final bacterial concentration of about between 10⁹-10¹² colony forming units (CFU) per gram of the formulation. The inert carrier is at a concentration of about between 45-95% (w/w). The inert carrier is for example, dextrose monohydrate. The organic emulsifier is at a concentration of about between 5 to 15% (w/w). The organic emulsifier is for example, soy lecithin.

In other aspects the invention provides an aqueous solution containing the water soluble formulation of the invention and a nitrogen source. The final bacterial concentration is about between 10⁵-10¹¹ colony forming units (CFU) per milliliter. The nitrogen source is a fertilizer having an NPK rating between 3-4-0 and 25-50-25. Optionally, the aqueous solution further includes a soil dispersing agent. The soil dispersing agent is for example, sodium or potassium tripolyphosphate, sodium or potassium orthophosphate, sodium or potassium pyrophosphate, sodium or potassium hexametaphosphate; citric acid, tartrate mono- and di-succinates, sodium silicate, ethoxylated diamines, polyacrylate polmers, modified cellulose polymers, lignosulfonates, modified starches, copolymers of methylvinyl ether and maleic anhydride (e.g. Gantrez™), any water-soluble salts of homo- and copolymers of aliphatic carboxylic acids such as maleic acid, itaconic acid, mesaconic acid, fumaric acid, aconitic acid, citraconic acid, methylenedmalonic acid, and mixtures thereof.

In various aspects the invention provides a process for remediating oil contaminated substrates by grinding the substrate to a particle size less than 1000 microns to produce a ground substrate; adding the ground substrate to the aqueous solutions according to the invention.

In other aspects the invention provides a process for remediating oil contaminated substrates by grinding the substrate to a particle size less than 1000 microns to produce a ground substrate; partially filling a vessel with water; adding an aqueous solutions according to the invention to the vessel; adding the ground substrate to the vessel; adding additional water to the vessel until it is +95% (v/v) full; and mixing the contents of the vessel for at least 72 hours to achieve the desired level of oil remediation.

The substrate is soil, cuttings from oil or gas drilling, sediment, or aquifer material.

In various embodiments the process further includes mixing the ground substrate with sand at a ratio of 1:1 by weight to produce a ground substrate:sand mixture. In some aspects the ground soil:sand mix is dispersed in an aqueous solution comprising 5-25% v/v of a water miscible solvent. Exemplary water miscible solvents include acetone, acetaldehyde, acetonitrile, 1,2 butanediol, 1,4 butanediol, 2-butoxyethanol, diethanolamine, dimethyl sulfoxide, 1,4 dioxane, ethanol, ethylamine, ethylene glycol, glycerol, methanol, methyl diethanolamine, 1-propanol, 1,3 propanediol, 2-propanol, propylene glycol, pyridine, tetrahydrofuran, and triethylene glycol.

Unless otherwise defined, all technical and scientific terms used herein have the same meaning as commonly understood by one of ordinary skill in the art to which this invention pertains. Although methods and materials similar or equivalent to those described herein can be used in the practice of the present invention, suitable methods and materials are described below. All publications, patent applications, patents, and other references mentioned herein are expressly incorporated by reference in their entirety. In cases of conflict, the present specification, including definitions, will control. In addition, the materials, methods, and examples described herein are illustrative only and are not intended to be limiting.

Other features and advantages of the invention will be apparent from and encompassed by the following detailed description and claims.

### BRIEF DESCRIPTION OF THE DRAWINGS

FIG. 1 shows cumulative carbon dioxide production of hydrocarbon contaminated samples treated with the microbial composition of Example 2.

FIG. 2 shows cumulative carbon dioxide production of hydrocarbon contaminated samples treated with the microbial composition of Example 5.

FIG. 3 shows the general process flow diagram for treating hydrocarbon contaminated drill cuttings from an oil well drilling operation with the bacterial compositions of the invention.

FIG. 4 shows a preferred process flow diagram for treating hydrocarbon contaminated soil with the bacterial compositions of the invention.

### DETAILED DESCRIPTION OF THE INVENTION

The invention provides microbial compositions to reduce hydrocarbons in soil and water and methods of using the compositions to reduce hydrocarbon contaminant from soil and water. The microbial composition contains mixtures of Pseudomonas and Bacillus. Optionally, the microbial composition further contains at least one additional bacteria selected from the genus Rhodococcus, Arthrobacter or Ochrobactrum.

The microbial compositions reduce and/or eliminate hydrocarbon contamination from soil, sediment, aquifer material and water.

The term “microbial compositions” as used herein refers to microorganisms conferring a benefit. The microbial compositions according to the invention may be viable or non-viable. The non-viable compositions are metabolically-active. By “metabolically-active” is meant that they exhibit at least some residual enzyme activity characteristic of the microbes in the mix.

By the term “non-viable” as used herein is meant a population of bacteria that is not capable of replicating under any known conditions. However, it is to be understood that due to normal biological variations in a population, a small percentage of the population (i.e. 5% or less) may still be viable and thus capable of replication under suitable growing conditions in a population which is otherwise defined as non-viable.

By the term “viable bacteria” as used herein is meant a population of bacteria that is capable of replicating under suitable conditions under which replication is possible. A population of bacteria that does not fulfill the definition of “non-viable” (as given above) is considered to be “viable”.

Unless stated otherwise, all percentages mentioned in this document are by weight based on the total weight of the composition.

The microbial compositions used in the product according to the present invention may contain any conventional bacteria. It is preferred that the bacteria are selected from the families Bacillaceae and Pseudomonadaceae.

Suitable types of bacteria which may be used include the following Bacillus subtilis, Bacillus amyloliquefaciens, Bacillus licheniformis, Bacillus niacin, Bacillus pumilis, Bacillus thurengiensis, Bacillus cereus, Bacillus napthovorans, Bacillus megaterium Pseudomonas zooglea, Pseudomonas alkaligenes, Pseudomonas frateuria, Pseudomonas putida, Pseudomonas aeruginosa, Pseudomonas azotifigens, Pseuodomonas azotoformans, Pseudomonas chlororaphis, Pseudomonas corrugata, Pseudomonas extremorientalis, Pseudomonas fiavescens, Pseudomonas fragi, Pseudomonas graminis, Pseudomonas japonica, Pseudomonas marginalis, Pseudomonas migulae, Pseudomonas monteilii, Pseudomonas mosselii, Pseudomonas nitroducens, Pseudomonas olveovorans, Pseudomonas plecoglossicida, Pseudomonas pseudoalcaligenes, Pseudomonas psychrophila, Pseudomonas stutzeri, Pseudomonas taiwanensis, Pseudomonas veronii, and Pseudomonas fluorescens.

Optionally, the microbial composition further contain at least one additional bacterium selected from the genus Rhodococcus, Arthrobacter, and Ochrobactrum. For example the composition further includes at least one bacterium selected from Rhodococcus zopfii, Rhodococcus rhodochrous, Arthrobacter roseoparaffinus, Arthrobacter petroleophagus, Arthrobacter paraffineus, Arthrobacter rubellus, or Ochrobactrum anthropi.

In one embodiment, the bacteria are present in equal proportions. In another embodiment the ratio of Bacillus to Pseudomonas is between 1:1 and 1:10.

The levels of the bacteria to be used according to the present invention will depend upon the types thereof. It is preferred that the present product contains bacteria in an amount between 10⁵ and 10¹¹ colony forming units per gram.

The bacteria according to the invention may be produced using any standard fermentation process known in the art. For example, solid substrate or submerged liquid fermentation. The fermented cultures can be mixed cultures or single isolates.

The bacterial compositions may be in liquid or powdered, dried form; preferably in spore form for microorganisms which form spores.

The powdered, dried compositions according to the invention have been freeze dried to moisture content less than 20%, 15%, 10%, 9%, 8%, 7%, 6%,5%, 4%, 3%, 2% or 1%. Preferably, the composition according to the invention has been freeze dried to moisture content less than 5%. In some embodiments the freeze dried powder is ground to decrease the particle size. For example the particle size is less than. 1000, 900, 800, 700, 600, 500, 400, 300, 200, 100 microns or less. In various embodiments the freeze dried powder is homogenized. In other embodiments the freeze dried powder is formulated such that it is water soluble. For example, the freeze dried power is mixed with dextrose. In yet other embodiments the freeze dried powder is formulated with nutrients, including a nitrogen and phosphorous source, to promote growth. For example, the freeze dried powder is mixed with diammonium phosphate, monoammonium phosphate, ammonium nitrate, urea, or ammonium dihydrogen phosphate.

Further, if desired, the bacterial compositions may be encapsulated to further increase the probability of survival; for example in a sugar matrix, fat matrix or polysaccharide matrix or integrated as a biofilm on a solid support carrier (using a grain-based material such as rice bran, soy, and/or wheat) via solid state fermentation.

In various embodiments, the bacterial compositions are formulated into water soluble formulations including an inert carrier, an organic emulsifier and a yeast extract, where the final bacterial concentration is between 10⁹-10¹² colony forming units (CFU) per gram of the formulation.

The inert carrier is for example, dextrose monohydrate. The dextrose monohydrate is at a concentration of at least 40%, 45%, 50%, 55%, 60%, 70%, 75%, 80%, 85%, 90%, 95% or more. Preferably, the dextrose monohydrate is at a concentration of about between 45-95% (w/w).

The organic emulsifier is for example, soy lecithin. The organic emulsifier is at a concentration of about 1%, 2%, 3%, 4%, 5%, 5, 7%, 8%, 9%, 10%, 11%, 12%, 13%, 14%, 15% or more. Preferably, the organic emulsifier is at a concentration of between 5 to 15% (w/w).

In other embodiments, the invention provides aqueous solutions including the water soluable formulations and a nitrogen source. The final bacterial concentration in the aqueous solution is about between 10⁵-10¹¹ colony forming units (CFU) per milliliter.

The nitrogen source is for example, a fertilizer having an NPK rating between 3-4-0 and 25-50-25.

Optionally, the aqueous solution further includes a soil dispersing agent. The soil dispersing agent is for example, sodium or potassium tripolyphosphate, sodium or potassium orthophosphate, sodium or potassium pyrophosphate, sodium or potassium hexametaphosphate, citric acid, tartrate mono- and di-succinates, sodium silicate, ethoxylated diamines, polyacrylate polmers, modified cellulose polymers, lignosulfonates, modified starches, copolymers of methylvinyl ether and maleic anhydride (e.g. Gantrez™), any water-soluble salts of homo- and copolymers of aliphatic carboxylic acids such as maleic acid, itaconic acid, mesaconic acid, fumaric acid, aconitic acid, citraconic acid, methylenedmalonic acid, and mixtures thereof.

The bacterial compositions, water soluble formulations and aqueous solutions of the invention are for hydrocarbon remediation.

The remediation method can be carried out in a variety of reactors including columns, reservoirs, or batch reactors. Alternatively, the contaminated site can be remediated in situ without removing the soil, water, or sediment from the ground. In one preferred embodiment the contaminated soil is first ground to a particle size less than 1000 microns, preferably less than 500 microns, then mixed with water containing the microbial compositions of the invention and a specified amount of nutrient (fertilizer with an NPK rating of 20-20-20). This mixture is stirred for up to 72 hours before removing the remediated soil, blending with limestone or other suitable, uncontaminated material, then transferred to a land site.

In another preferred embodiment the soils is ground to a particle size less than about 500 microns then diluted 1:1 on a weight basis with sand. A soil dispersing agent is then added to the aqueous mixture along with the substrate to be remediated, the microbial composition, and a nitrogen source. Any organic or inorganic dispersing agent may be used including, but not limited to, sodium or potassium tripolyphosphate, sodium or potassium orthophosphate, sodium or potassium pyrophosphate, sodium or potassium hexametaphosphate, citric acid, tartrate mono- and di-succinates, sodium silicate, ethoxylated diamines, polyacrylate polmers, modified cellulose polymers, lignosulfonates, modified starches, copolymers of methylvinyl ether and maleic anhydride (e.g. Gantrez™) or any water-soluble salts of homo- and copolymers of aliphatic carboxylic acids such as maleic acid, itaconic acid, mesaconic acid, fumaric acid, aconitic acid, citraconic acid, and methylenedmalonic acid, and mixtures thereof.

In yet another preferred embodiment the soil is ground to a particle size less than about 500 microns, diluted 1:1 with uncontaminated sand, and dispersed via mixing into an aqueous mixture comprising from 5 to 25% v/v of a water miscible solvent. After mixing this composition for a period of time an aqueous solution containing the microbial composition and a nitrogen source is added, the entire mixture stirred for up to 72 hours, then filtered to remove the soil. The filtered soil is then admixed with limestone or another suitable material and transferred to a land site. The aqueous filtrate from this process can be recycled and used in the next clean-up cycle. Suitable water miscible solvents include acetone, acetaldehyde, acetonitrile, butanediol, 1,4 butanediol, 2-butoxyethanol, diethanolamine, dimethyl sulfoxide, 1,4 dioxane, ethanol, ethylamine, ethylene glycol, glycerol, methanol, methyl diethanolamine, 1-propanol, 1,3 propanediol, 2-propanol, propylene glycol, pyridine, tetrahydrofuran, and triethylene glycol.

A better understanding of the present invention may be given with the following examples which are set forth to illustrate, but are not to be construed to limit the present invention.

### EXAMPLES

### Example 1

### Preparation of the Microbial Species Via Submerged Fermentation

The microbes of the present invention are grown using standard deep tank submerged fermentation processes known in the art

Individual starter cultures of Bacillus subtilis, Bacillus amyloliquefaciens, Bacillus licheniformis, Bacillus pumilus, Pseudomonas fluorescens, and Pseudomonas putida are grown in submerged fermentation tanks under conditions specific to each species for optimal growth. For example, the Bacillus organisms were grown according to the following general protocol: 2 grams Nutrient Broth, 2 grams AmberFerm (yeast extract) and 4 grams Maltodextrin are added to a 250 ml Erlenmeyer flask. 100 mls distilled, deionized water is added and the flask is stirred until all dry ingredients are dissolved. The flask is covered and placed for 30 min in an Autoclave operating at 121° C. and 15 psi. After cooling, the flask is inoculated with 1 ml of one of the pure microbial strains. The flask is sealed and placed on an orbital shaker at 30° C. Cultures are allowed to grow for 3-5 days. This process is repeated for each of the Bacillus species in the mixture.

Larger Bacillus cultures are prepared by adding 18 grams Nutrient Broth, 18 grams AmberFerm, and 36 grams Maltodextrin to 1 liter flasks with 900 mls distilled, deionized water. The flasks are sealed and sterilized as above. After cooling, 100 mls of the microbial media from the 250 ml Erlenmeyer flasks are added. The 1 liter flasks are sealed, placed on and orbital shaker, and allowed to grow out for another 3-5 days at 30° C.

In the final grow-out phase before introduction to the fermenter, the cultures from the 1 liter flasks are transferred under sterile conditions to sterilized 6 liter vessels and fermentation continued at 30° C. with aeration until stationary phase is achieved. The contents of each 6 liter culture flask are transferred to individual fermenters which are also charged with a sterilized growth media made from 1 part yeast extract and 2 parts dextrose. The individual fermenters are run under aerobic conditions at the pH and temperature optima for each species:

| Microbe | Temperature Optimum |
|---|---|
| Bacillus subtilis | 35° C. |
| Bacillus amyloliquefaciens | 30° C. |
| Bacillus licheniformis | 37° C. |
| Bacillus pumilus | 30° C. |
| Pseudomonas fluorescens | 27° C. |
| Pseudomonas putida | 30° C. |

Each fermenter is run until cell density reaches 10¹¹ CFU/ml, on average. The individual fermenters are then emptied, filtered, and centrifuged to obtain the bacterial cell mass which is subsequently dried under vacuum until moisture levels drop below 5%. The individual dried microbes are then mixed together to give a total Bacillus to Pseudomonas ratio of 1:1.

The final microbial count of the dried samples is typically 10¹⁰-10¹² CFU/g.

### Example 2

### Formulation of the Hydrocarbon Remediation Product Using Microbes from Example 1

A water soluble formulation is prepared by mixing the dried microbial mix of Example 1 with a dry powdered medium including soy digest (9% w/w), yeast extract (36% w/w), and dextrose (55% w/w), to achieve a final composition with bacterial activity between 10⁹ and 10¹¹ cfu/g.

### Example 3

### Performance of the Hydrocarbon Remediation Product from Example 2

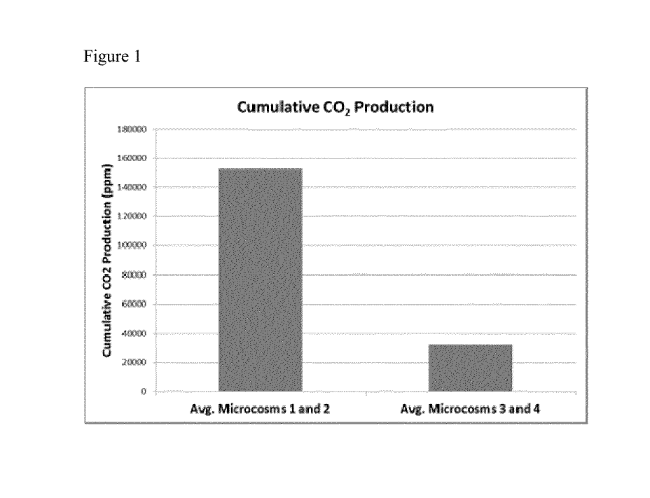

A total of 6 microcosms were prepared in sterilized 2-L Pyrex media bottles. To prepare the microcosms, 178 g of sieved Los Osos sand were weighed out and 2 grams of SAE 30 motor oil added to achieve an approximate hydrocarbon concentration of 10,000 ppm. Microcosms 1 and 2 were inoculated with 15,000 ppm of the water soluble formulation of Example 2. Microcosms 3 and 4 were similarly inoculated but no motor oil was added. Microcosms 5 and 6 were contaminated with motor oil but no microbial inoculum. DI water was added to all microcosms so that the total moisture content was 10%. 5.0 ml of 125 g/1 Miracle-Gro™ was added to all microcosms to ensure there were sufficient nutrients for hydrocarbon degradation. Each of the 2-L Pyrex media bottles were immersed in a circulating water bath held at 30° C. and connected to a Micro-Oxymax™ Respirometer (Columbus Instruments: Columbus, Ohio) equipped with carbon dioxide, methane and oxygen sensors, a 10-channel expansion interface and a condensing air drier. Each microcosm was continuously monitored for CO₂ evolution over a 170 hour time period. Cumulative CO₂ production Results are shown in FIG. 1. The results clearly indicate that hydrocarbons are being utilized and the microbial composition of the invention dramatically increases in metabolic rate fuelled by the hydrocarbon fuel source.

### Example 4

### Expanded Microbial Composition for Hydrocarbon Remediation

A composition comprising the bacterial strains from Example 1 and additional microbes selected for their ability to provide additional hydrocarbon remediation benefits is designed using a fermentation system similar to that developed in Example 1.

Individual starter cultures of Bacillus subtilis, Bacillus amyloliquefaciens, Bacillus licheniformis, Bacillus pumilus, Pseudomonas fluorescens, Pseudomonas putida, Rhodococcus zopfii, Arthrobacter rseoparaffinus, Arthrobacter petroleophagus, Arthrobacter paraffineus, Rhodococcus rhodochrous, Ochrobactrum anthropic, and Arthrobacter rubellus are grown in submerged fermentation tanks under conditions specific to each species for optimal growth. The individual fermenters are run under aerobic conditions at the pH and temperature optima for each species:

| Microbe | Temperature Optimum |
|---|---|
| Bacillus subtilis | 35° C. |
| Bacillus amyloliquefaciens | 30° C. |
| Bacillus licheniformis | 37° C. |
| Bacillus pumilus | 30° C. |
| Pseudomonas fluorescens | 27° C. |
| Pseudomonas putida | 30° C. |
| Rhodococcus zopfii | 20° C. |
| Arthrobacter roseoparaffinus | 30° C. |
| Arthrobacter petroleophagus | 25° C. |
| Arthrobacter paraffineus | 27° C. |
| Rhodococcus rhodochrous | 26° C. |
| Ochrobactrum anthropi | 30° C. |
| Arthrobacter rubellus | 30° C. |

Each fermenter is run until cell density reaches 10¹¹ CFU/ml, on average. The individual fermenters are then emptied, filtered, centrifuged to obtain the bacterial cell mass which is subsequently dried under vacuum until moisture levels drop below 5%, and mixed together in equal proportions. The final microbial count of the dried samples is 10¹⁰-10¹² CFU/g.

### Example 5

### Formulation of the Hydrocarbon Remediation Product from the Expanded Set of Microbes in Example 4

A water soluble formulation is prepared by mixing the dried microbial mix of Example 4 with a dry powdered medium including soy digest (9% w/w), yeast extract (36% w/w), and dextrose (55% w/w), to achieve a final composition with bacterial activity between 10⁹ and 10¹¹ cfu/g.

### Example 6

### Performance of the Expanded Microbial Set in Hydrocarbon Remediation

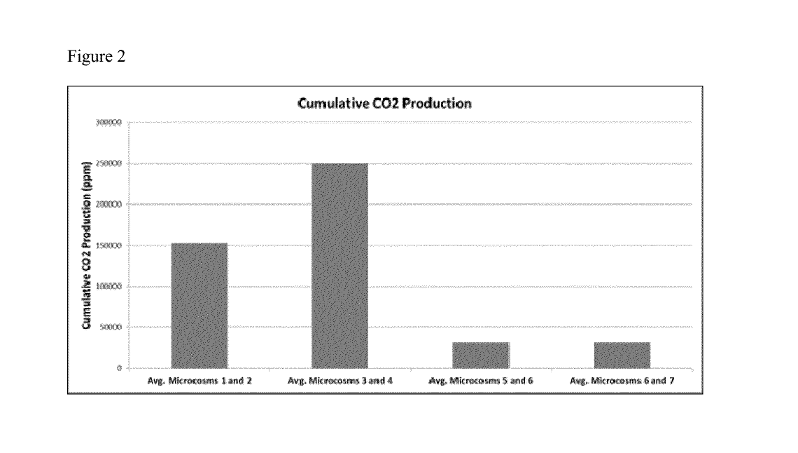

A total of 10 microcosms were prepared in sterilized 2-L Pyrex media bottles. To prepare the microcosms, 178 grams of sieved Los Osos sand were weighed out and 2 grams of SAE 30 motor oil added to achieve an approximate hydrocarbon concentration of 10,000 ppm. Microcosms 1 and 2 were inoculated with 15,000 ppm of the water soluble formulation of Example 2. Microcosms 3 and 4 were inoculated with 15,000 ppm of the water soluble formulation of Example 5. Microcosms 5 and 6 were inoculated with 15,000 ppm of the water soluble formulation of Example 2 but no oil was added. Similarly, Microcosms 7 and 8 were inoculated with 15,000 ppm of the water soluble formulation of Example 5 but no oil was added. Microcosms 9 and 10 were contaminated with motor oil but no microbial inoculum. DI water was added to all microcosms so that the total moisture content was 10%. 5.0 ml of 125 g/l Miracle-Gro™ was added to all microcosms to ensure there were sufficient nutrients for hydrocarbon degradation. Each of the 2-L Pyrex media bottles were immersed in a circulating water bath held at 30° C. and connected to a Micro-Oxymax™ Respirometer (Columbus Instruments: Columbus, Ohio) equipped with carbon dioxide, methane and oxygen sensors, a 10-channel expansion interface and a condensing air drier. Each microcosm was continuously monitored for CO₂ evolution over a 170 hour time period. Cumulative CO₂ production Results are shown in FIG. 2.

### Example 7

### A Process for Remediating Drill Cuttings Using the Bacterial Compositions of the Invention

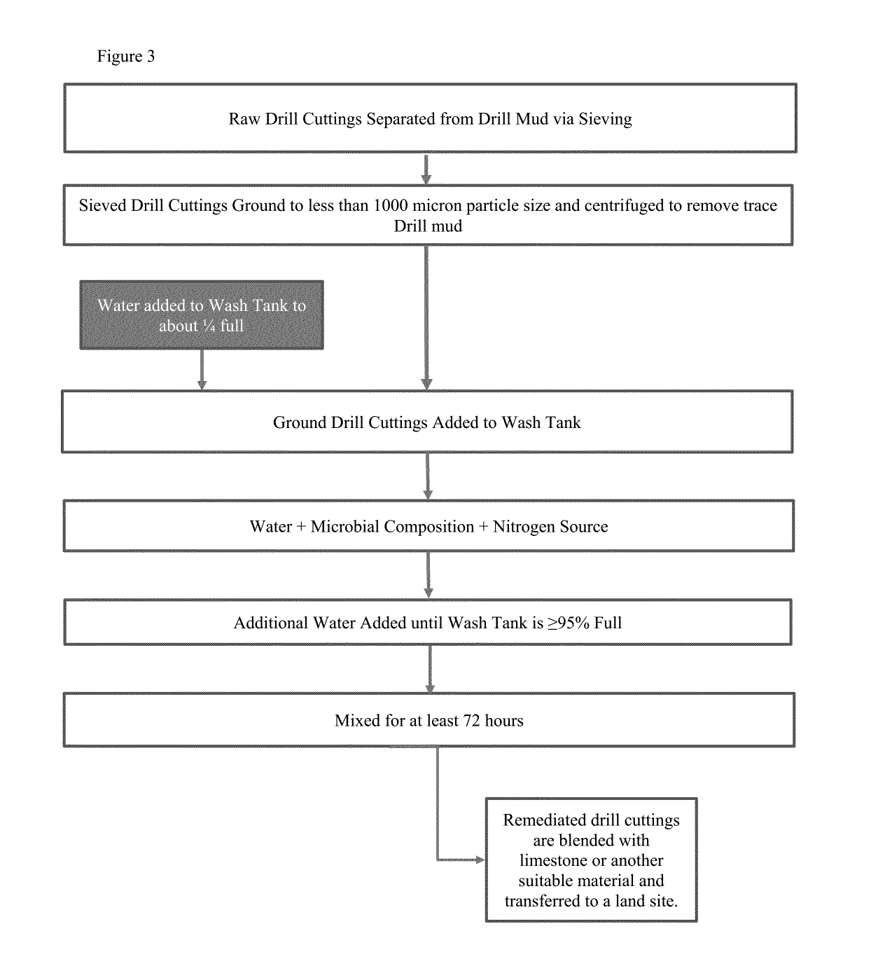

FIG. 3 shows the general block flow diagram for a full-scale process to remediate cuttings from oil/gas drilling rigs, The raw cuttings from the bore hole are passed through a series of sieve screens to separate drill cuttings from the bore cuttings. The retains on the screens are ground to a particle size less than 1000 microns and centrifuged to extract additional mud which is returned to a storage tank for further use in the drilling operation. The ground and dried cuttings are transferred to a wash tank where an aqueous solution comprising the microbial composition plus a nitrogen source is added according to the following protocol:
1. The wash tank is filled about one quarter full with water.
2. An aqueous solution comprising 0.3 kg/gallon of the microbial composition from Example 5 plus 0.5 lbs/gallon of a 20-20-20 NPK rated fertilizer is added to the wash tank;
3. The dried, ground drill cuttings are added until the wash tank is filled to approximately 50% capacity;
4. Additional water is added to the wash tank leaving approximately 1 foot of free space between the aqueous layer and the top of the tank (˜95% full);
5. The contents of the prewash tank are then mixed. Mixing is done every 4 hours for up to 72 hours total;

At the conclusion of the wash cycle the contents of the mix tank are transferred to another tank and blended with limestone or another suitable material. This material is then transferred to a land site. With this process the percentage of oil in the contaminated cuttings can be reduced from about 20% to below 5% (as determined via a modified retort method).

### Example 8

### Effect of Soil Dispersing Agent on the Remediation of Contaminated Drill Cuttings

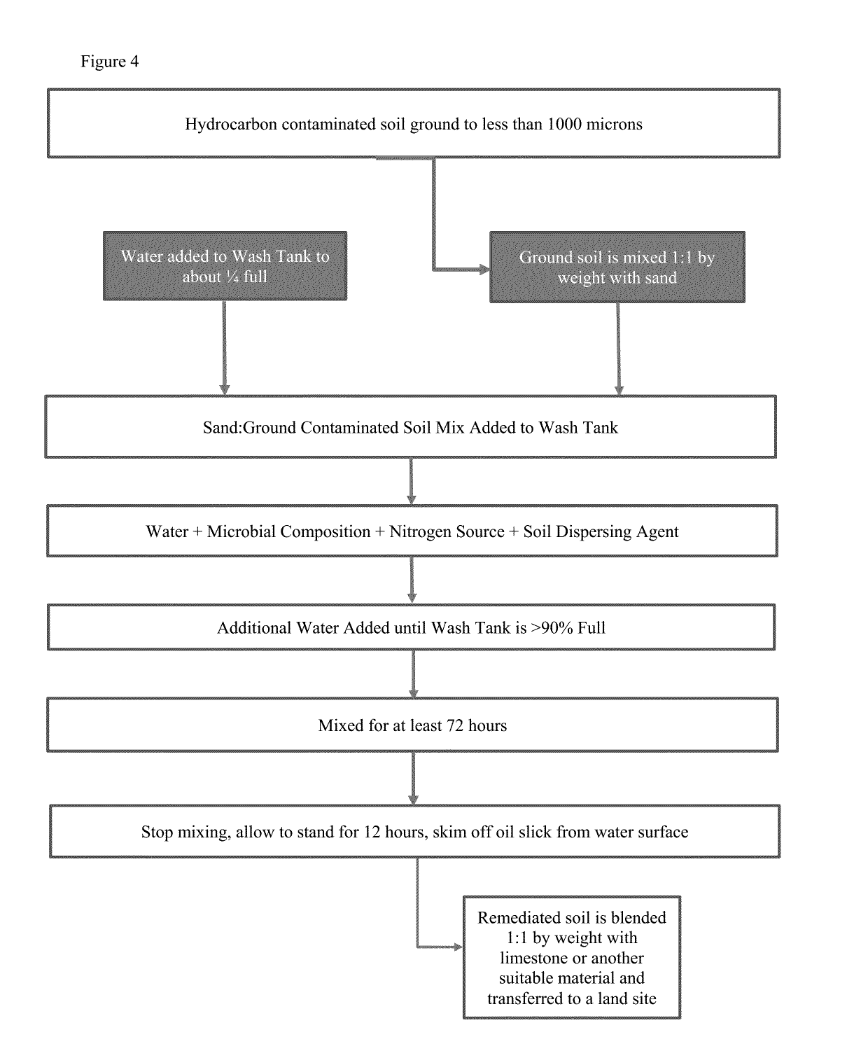

FIG. 4 shows the general block flow diagram for a full-scale process to remediate oil contaminated soil. The addition of the dispersing agent and sand causes the soil to more evenly disperse in the aqueous phase allowing better mixing and more contact between the microbes and the oil associated with the soil. In this process it is common for a significant portion of the oil to separate from the soil and rise to the surface of the wash tank. The process includes a method for skimming this oil layer off prior to disposal of the soil. Using this protocol we measure +90% remediation of the oil.

### Example 9

### Preparation of the Microbial Composition Via Solid Substrate Fermentation

The microbial compositions of the present invention may also be produced via solid substrate fermentation according to the following process:

Four pounds of Dairy 12% Mineral Mix, 60 lbs Rice bran, and 30 lbs Soybean meal were added to a jacketed, horizontal mixer with screw auger. Water and steam were added with mixing to obtain slurry. After mixing for 2 minutes, 300 lbs wheat bran was added to the mixer followed by more water and steam to re-make the slurry. With the mixer temperature controlled to 35-36° C., 4 lbs of a dry microbial mixture comprising Bacillus subtilis, Bacillus amyloliquefaciens, Bacillus licheniformis, Bacillus pumilus, Pseudomonas fluorescens, and Pseudomonas putida with an initial microbial activity of about 1×1010 CFU/g, were added. The mixer was closed; temperature adjusted to 30° C., and the contents allowed to mix for up to 4 days. After fermentation the contents of the mixer were emptied onto metal trays and allowed to air dry. After drying, the product was ground to a particle size below about 200 microns. The final product obtained had a microbial count on the order of 1×1011 CFU/g and less than about 5% moisture.

We claim:

1. A composition for hydrocarbon remediation, comprising a microbial mixture of Bacillus and Pseudomonas organisms, wherein each of the organisms, in the mixture is individually aerobically fermented, harvested, dried, and ground to produce a powder having a mean particle size of about 200 microns, with greater than about 60% of the mixture in the size range between 100-800 microns.

2. The composition of claim 1, wherein the composition upon addition to water fully disperses and does not require a preactivation of the bacteria.

3. The composition of claim 1, wherein the ratio of the Bacillus to Pseudomonas is between 1:1 to 1:10.

4. The composition of claim 1, wherein each of the Bacillus organisms or the Pseudomonas organisms, are present in equal proportions.

5. The composition of claim 1, wherein the composition has a moisture content of less than about 5%; and a final bacterial concentration of about between 10⁸-10¹² colony forming units (CFU) per gram of the composition.

6. The composition of claim 1, wherein the microbial mixture further comprises at least one bacterium selected from the genus Rhodococcus, Arthrobacter, and Ochrobactrum.

7. The composition of claim 1, wherein the Bacillus organisms are selected from the group consisting of Bacillus subtilis, Bacillus amyloliquefaciens, Bacillus licheniformis, Bacillus niacin, Bacillus pumilis, Bacillus thurengiensis, Bacillus cereus, Bacillus napthovorans, and Bacillus megaterium.

8. The composition of claim 1, wherein the Pseudomonas organisms are selected from the group consisting of Pseudomonas zooglea, Pseudomonas alkaligenes, Pseudomonas frateuria, Pseudomonas putida, Pseudomonas aeruginosa, Pseudomonas azotifigens, Pseuodomonas azotoformans, Pseudomonas chlororaphis, Pseudomonas corrugata, Pseudomonas extremorientalis, Pseudomonas fiavescens, Pseudomonas fragi, Pseudomonas graminis, Pseudomonas japonica, Pseudomonas marginalis, Pseudomonas migulae, Pseudomonas monteilii, Pseudomonas mosselii, Pseudomonas nitroducens, Pseudomonas olveovorans, Pseudomonas plecoglossicida, Pseudomonas pseudoalcaligenes, Pseudomonas psychrophila, Pseudomonas stutzeri, Pseudomonas taiwanensis, Pseudomonas veronii, and Pseudomonas fluorescens.

9. The composition of claim 6, wherein the Rhodococcus organism is Rhodococcus zopfii or Rhodococcus rhodochrous.

10. The composition of claim 6, wherein the Arthrobacter organism is Arthrobacter roseoparaffinus, Arthrobacter petroleophagus, Arthrobacter paraffineus, or Arthrobacter rubellus,

11. The composition of claim 6, wherein the Ochrobactrum organism is Ochrobactrum anthropic.

12. The composition of claim 1, wherein the microbial mixture comprises Bacillus subtilis, Bacillus amyloliquefaciens, Bacillus licheniformis, Bacillus pumilus, Pseudomonas fluorescens, and Pseudomonas putida.

13. The composition of claim 6, wherein the microbial mixture comprises Bacillus subtilis, Bacillus amyloliquefaciens, Bacillus licheniformis, Bacillus pumilus, Pseudomonas fluorescens, Pseudomonas putida, Rhodococcus zopfii, Arthrobacter rseoparaffinus, Arthrobacter petroleophagus, Arthrobacter paraffineus, Rhodococcus rhodochrous, Ochrobactrum anthropic, and Arthrobacter rubellus.

14. A water soluble formulation comprising the composition of claim 1, an inert carrier, am organic emulsifier and a yeast extract, wherein the final bacterial concentration of about between 10⁹-10¹² colony forming units (CFU) per gram of the formulation.

15. The formulation of claim 14, wherein the inert carrier is at a concentration of about between 45-95% (w/w).

16. The formulation of claim 15 wherein the inert carrier is dextrose monohydrate.

17. The formulation of claim 14, wherein the organic emulsifier is at a concentration of about between 5 to 15% (w/w).

18. The formulation of claim 17, wherein in the organic emulsifier is soy lecithin.

19. An aqueous solution comprising the formulation of claim 14 and a nitrogen source

20. The aqueous solution of claim 19, wherein the final bacterial concentration is about between 10⁵-10¹¹ colony forming units (CFU) per milliliter.

21. The aqueous solution of claim 19, wherein the nitrogen source is a fertilizer having an NPK rating between 3-4-0 and 25-50-25.

22. The aqueous solution of claim 19, wherein the aqueous solution further comprising a soil dispersing agent.

23. The aqueous solution of claim 22, wherein the soil dispersing agent is selected from the group consisting of sodium or potassium tripolyphosphate, sodium or potassium orthophosphate, sodium or potassium pyrophosphate, sodium or potassium hexametaphosphate, citric acid, tartrate mono- and di-succinates, sodium silicate, ethoxylated diamines, polyacrylate polmers, modified cellulose polymers, lignosulfonates, modified starches, copolymers of methylvinyl ether and maleic anhydride (e.g. Gantrez™), any water-soluble salts of homo- and copolymers of aliphatic carboxylic acids such as maleic acid, itaconic acid, mesaconic acid, fumaric acid, aconitic acid, citraconic acid, methylenedmalonic acid, and mixtures thereof.

24. A process for remediating an oil contaminated substrates comprising:
a) grinding the substrate to a particle size less than 1000 microns to produce a ground substrate;
b) adding the ground substrate to an aqueous solution comprising a microbial mixture of Bacillus, Pseudomonas, and a nitrogen source to produce a solution
c) stirring the solution for up to 72 hours.

25. The process of claim 24, wherein the microbial mixtures comprises Bacillus subtilis, Bacillus amyloliquefaciens, Bacillus licheniformis, Bacillus pumilus, Pseudomonas fluorescens, and Pseudomonas putida.

26. The process of claim 24, wherein the ratio of Bacillus to Pseudomonas ratio is between 1:1 and 1:10.

27. A process for remediating an oil contaminated substrates comprising:
a. grinding the substrate to a particle size less than 1000 microns to produce a ground substrate;
b. partially filling a vessel with water;
c. adding an aqueous solution of a microbial mixture and a nitrogen source to the vessel;
d. adding the ground substrate to the vessel;
e. adding additional water to the vessel until it is +95% (v/v) full;
f. mixing the contents of the vessel for at least 72 hours to achieve the desired level of oil remediation.

28. The process of claim 27, wherein the microbial mixture comprises Bacillus and Pseudomonas in a ratio from 1:1 to 1:10.

29. The process of claim 27, wherein the microbial mixture comprises Bacillus subtilis, Bacillus amyloliquefaciens, Bacillus licheniformis, Bacillus pumilus, Pseudomonas fluorescens, and Pseudomonas putida.

30. The process of claim 27, wherein the nitrogen source is a fertilizer having an NPK rating between 3-4-0 and 25-50-25.

31. The process of claim 27, wherein the substrate is soil, cuttings from oil or gas drilling, sediment, or aquifer material.

32. The process of claim 29, wherein the microbial mixture further comprises at least one bacterium selected from the genus Rhodococcus, Arthrobacter, and Ochrobactrum.

33. The process of claim 32, wherein the Rodococcus bacterium is Rhodococcus zopfii or Rhodococcus rhodochrous

34. The process of claim 32, wherein the Arthrobacter bacterium is selected from the group comprising Arthrobacter rseoparaffinus, Arthrobacter petroleophagus, Arthrobacter paraffineus, and Arthrobacter rubellus

35. The process of claim 32, where in the Ochrobactrum is Ochrobactrum anthropic

36. The process of claim 27, wherein the microbial mixture comprises Bacillus subtilis, Bacillus amyloliquefaciens, Bacillus licheniformis, Bacillus pumilus, Pseudomonas fluorescens, Pseudomonas putida, Rhodococcus zopfii, Arthrobacter rseoparaffinus, Arthrobacter petroleophagus, Arthrobacter paraffineus, Rhodococcus rhodochrous, Ochrobactrum anthropic, and Arthrobacter rubellus

37. The process of claim 27, wherein the final bacterial concentration is about between 10⁵-10¹¹ colony forming units (CFU) per gram of the bacterial mixture.

38. The process of any of claim 27, wherein the aqueous solution further comprises a soil dispersing agent.

39. The process of any one of claim 27, further comprising mixing the ground substrate with sand at a ratio of 1:1 by weight to produce a ground substrate:sand mixture.

40. The process according to claim 38, wherein the soils dispersing agent is selected from the group consisting of sodium or potassium tripolyphosphate, sodium or potassium orthophosphate, sodium or potassium pyrophosphate, sodium or potassium hexametaphosphate, citric acid, tartrate mono- and di-succinates, sodium silicate, ethoxylated diamines, poly acrylate pointers, modified cellulose polymers, lignosulfonates, modified starches, copolymers of methylvinyl ether and maleic anhydride (e.g. Gantrez™) any water-soluble salts of homo- and copolymers of aliphatic carboxylic acids such as maleic acid, itaconic acid, mesaconic acid, fumaric acid, aconitic acid, citraconic acid, methylenedmalonic acid, and mixtures thereof.

41. The process according to claim 39, wherein the ground soil:sand mix is dispersed in an aqueous solution comprising 5-25% v/v of a water miscible solvent.

42. The process of claim 41, wherein the water miscible solvent is selected from the group consisting of acetone, acetaldehyde, acetonitrile, 1,2 butanediol, 1,4 butanediol, 2-butoxyethanol, diethanolamine, dimethyl sulfoxide, 1,4 dioxane, ethanol, ethylamine, ethylene glycol, glycerol, methanol, methyl diethanolamine, 1-propanol, 1,3 propanediol, propanol, propylene glycol, pyridine, tetrahydrofuran, and triethylene glycol.
